(19) United States
(12) Patent Application Publication
(10) Pub. No.: US 2025/0004807 A1
(43) Pub. Date: Jan. 2, 2025

(54) PROACTIVELY PREEMPTING QUORUM LOSS IN DISTRIBUTED COMPUTING SYSTEMS

(71) Applicant: INTERNATIONAL BUSINESS MACHINES CORPORATION, Armonk, NY (US)

(72) Inventors: Scott Carrier, New Hill, NC (US); Hidematsu Atom Sueki, Morrisville, NC (US); BAKER HAMILTON PRATT, Chapel Hill, NC (US); JUSTIN KANZ, Durham, NC (US)

(21) Appl. No.: 18/216,753

(22) Filed: Jun. 30, 2023

(51) Int. Cl. G06F 9/455

(52) U.S. Cl. CPC G06F 9/45558; G06F 2009/4557

(57) ABSTRACT

A method, system, and computer program product are configured to: intercept an instruction that originates external to a cluster, wherein the cluster comprises plural nodes each running a consensus component, and wherein a defined number of the consensus components are required for quorum; predict a change to a current state of the cluster based on the instruction; determine whether the change to the current state of the cluster would result in quorum loss; in response to determining the change to the current state of the cluster would result in quorum loss, prevent execution of the instruction; and in response to determining the change to the current state of the cluster would not result in quorum loss, permit execution of the instruction.

### BACKGROUND

Aspects of the present invention relate generally to distributed computing systems and, more particularly, to proactively preempting quorum loss in distributed computing systems.

A quorum is the minimum number of votes that a distributed transaction has to obtain in order to be allowed to perform an operation in a distributed computing system. A quorum-based technique is implemented to enforce consistent operation in a distributed computing system.

Cluster computing is a form of distributed computing. Some cluster computing systems use distributed consensus based on a quorum, which requires that a majority of members must agree on a proposal before it can be committed to a cluster.

### SUMMARY

In a first aspect of the invention, there is a computer-implemented method including: intercepting an instruction that originates external to a cluster, wherein the cluster comprises plural nodes each running a consensus component, and wherein a defined number of the consensus components are required for quorum; predicting a change to a current state of the cluster based on the instruction; determining whether the change to the current state of the cluster would result in quorum loss; in response to determining the change to the current state of the cluster would result in quorum loss, preventing execution of the instruction; and in response to determining the change to the current state of the cluster would not result in quorum loss, permitting execution of the instruction.

In another aspect of the invention, there is a computer program product including one or more computer readable storage media having program instructions collectively stored on the one or more computer readable storage media. The program instructions are executable to: intercept an instruction that originates external to a cluster, wherein the cluster comprises plural nodes each running a consensus component, and wherein a defined number of the consensus components are required for quorum; predict a change to a current state of the cluster based on the instruction; determine whether the change to the current state of the cluster would result in quorum loss; in response to determining the change to the current state of the cluster would result in quorum loss, prevent execution of the instruction; and in response to determining the change to the current state of the cluster would not result in quorum loss, permit execution of the instruction.

In another aspect of the invention, there is a system including a processor set, one or more computer readable storage media, and program instructions collectively stored on the one or more computer readable storage media. The program instructions are executable to: intercept an instruction that originates external to a cluster, wherein the cluster comprises plural nodes each running a consensus component, and wherein a defined number of the consensus components are required for quorum; predict a change to a current state of the cluster based on the instruction; determine whether the change to the current state of the cluster would result in quorum loss; in response to determining the change to the current state of the cluster would result in quorum loss, prevent execution of the instruction and sending an alert to a user that issued the instruction; and in response to determining the change to the current state of the cluster would not result in quorum loss, permit execution of the instruction.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIGS. 3A and 3B show an exemplary use case that illustrates aspects of the present invention.

FIG. 4 shows a flowchart of an exemplary method in accordance with aspects of the present invention.

### DETAILED DESCRIPTION

Aspects of the present invention relate generally to distributed computing systems and, more particularly, to proactively preempting quorum loss in distributed computing systems. Given the emergence of cluster computing technologies such as Kubernetes and OpenShift, customers are often managing multiple clusters comprising multiple nodes across different infrastructures. While cluster technologies often embody self-healing capabilities, certain state changes in the underlying infrastructure, such as taking down a node, can result in a degraded cluster state due to quorum loss.

A cluster deployed in a public cloud is controlled and operated by the public cloud provider. As a result, customers that utilize services provided by the cluster do not have control over the nodes included in the cluster. However, in a hybrid cloud deployment, a cluster may be running on nodes controlled and operated by a customer. For example, in a hybrid cloud deployment, applications are often run across a combination of customer on-premises nodes, edge nodes, and cloud computing nodes. In this situation, the customer may perform an action that affects one of the on-premises nodes of the cluster without realizing that doing so can cause a loss of quorum in the cluster. In one example, a customer may take down and replace the entire control plane of the cluster without realizing that doing so causes a loss of quorum in a distributed database that stores data about the state of the cluster. The resulting loss of quorum can take time to diagnose (e.g., days or even weeks) and also requires that the distributed database be restored from a backup, which involves more time and effort. This represents a shortcoming of conventional hybrid cloud deployments.

Implementations of the invention provide a technical solution to the above-noted problem by proactively preempting quorum loss in distributed computing systems such as hybrid cloud deployments. In embodiments, the solution comprises: intercepting a command that originates externally of a cluster; predicting a changed state of a cluster that would result from the command; determining whether the predicted state of the cluster satisfies a quorum requirement of the cluster; and preventing execution of the command when the predicted state of the cluster does not satisfy the quorum requirement of the cluster. In this manner, implementations of the invention may be used to intercept and block external commands that would cause a cluster to lose quorum. In this manner, implementations of the invention provide an improvement in distributed computing systems such as hybrid cloud deployments that utilize quorums.

In an aspect of the invention, a method, system, and computer program product are configured to: intercept commands and classify ones that could alter the state of cluster infrastructure; predict a future quorum state delta based on the command; reconcile a quorum state of the live cluster against the predicted state delta and determine whether the reconciled quorum state would constitute loss of quorum; and preempt the command from running with a message conveying the predicted loss of quorum that would ensue as a result. In embodiments, the predicting the future quorum state delta may be performed using one or more rules that are based on common commands and/or a machine learning algorithm that predicts impacts on a cluster based on a command.

In another aspect of the invention, a method, system, and computer program product are configured to: intercept a command external to a cluster and infer an alteration in cluster resource state, specifically resources affecting quorum; reconcile an inferred alteration in cluster resource state with the current state of a live cluster (i.e., the projected, future state of the cluster adjusting for the inferred alteration in cluster state stemming from the intercepted command external to the cluster); reconcile a projected state of the cluster with the quorum requirements of the cluster to identify whether quorum loss would ensue if the command external to the cluster were to be processed; reject the command external to the cluster if quorum loss is projected to ensue as a result of processing the command; and alert the user to the reason behind the rejection.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as quorum loss preemption code at block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

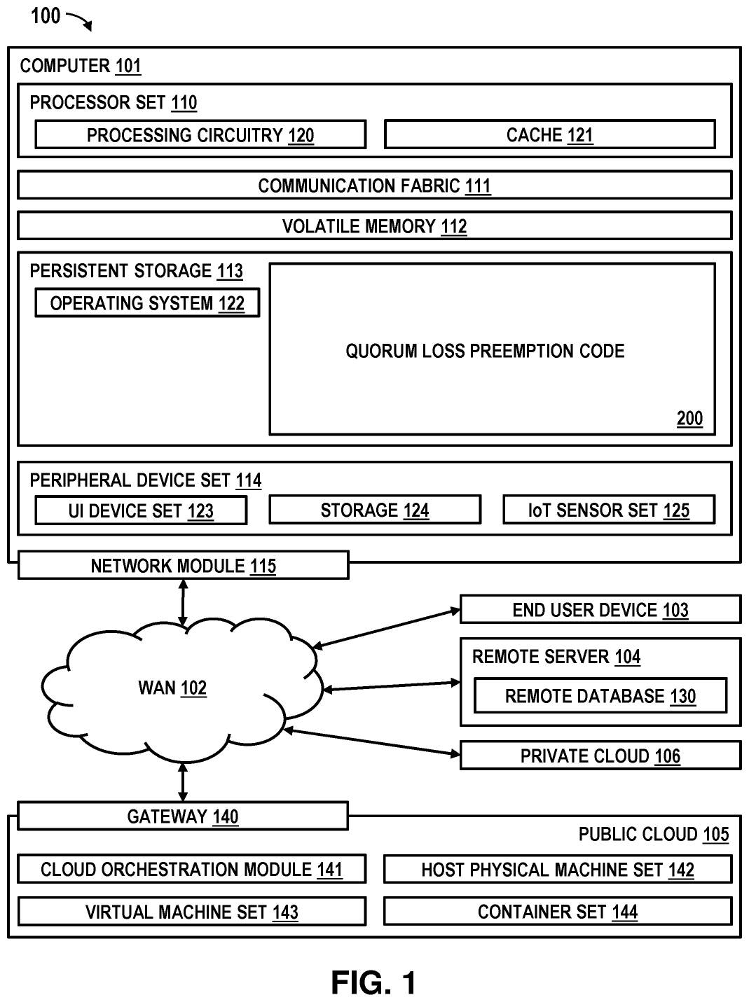

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

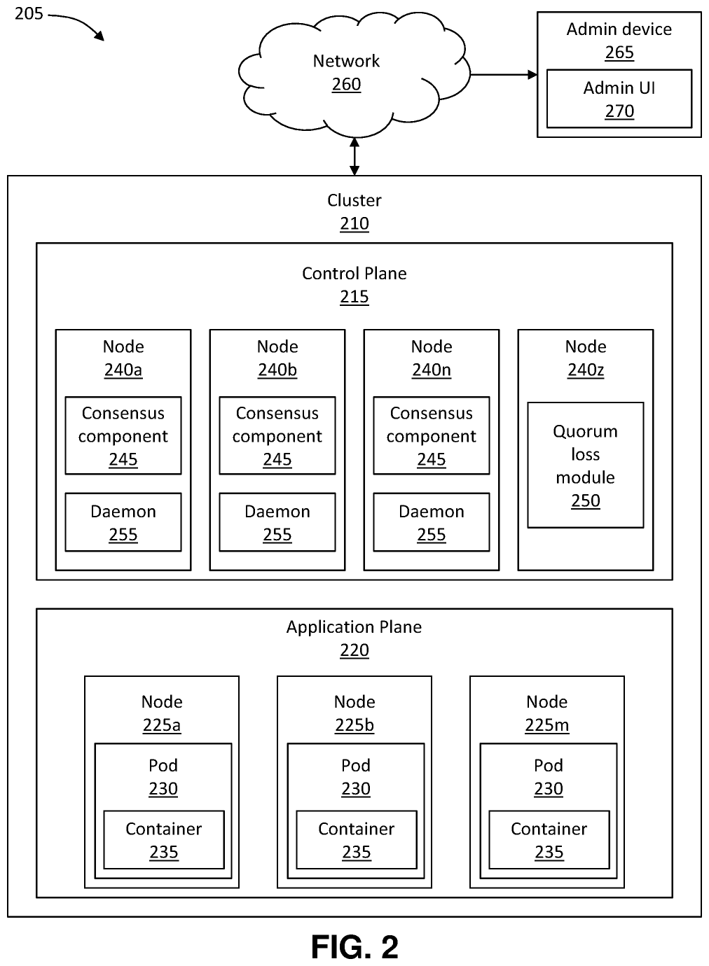

FIG. 2 shows a block diagram of an exemplary environment 205 in accordance with aspects of the invention. In embodiments, the environment 205 includes a cluster 210 that includes a control plane 215 and an application plane 220. In embodiments, the cluster 210 is a computing cluster. For example, the cluster 210 may comprise a Kubernetes cluster. In embodiments, the application plane 220 comprises “m” number of nodes 225a, 225b, . . . , 225m that run one or more applications that provide services to end user devices (not shown). In one example, each node 225a-m comprises a computing device (e.g., a bare-metal server or virtual machine) that hosts one or more pods 230. In this example, each pod 230 contains one or more containers such as Docker containers. In an exemplary operation, the pods 230 run on the nodes 225a-m and represent a single instance of a running process in the cluster 210. In embodiments, the control plane 215 manages the nodes 225a-m and the pods 230, e.g., via scheduling, scaling, and other operations.

In accordance with aspects of the invention, the control plane 215 comprises “n” number of nodes 240a, 240b, . . . , 240n, each of which comprises a computing device (e.g., a bare-metal server or virtual machine) that hosts an instance of a consensus component 245. In embodiments, the consensus components 245 comprise a distributed database. In an example, each of the consensus components 245 comprises a high-availability key-value store such as etcd. For example, each consensus component 245 may comprise an instance of etcd, which is an open source, distributed, consistent key-value store for shared configuration, service discovery, and scheduler coordination of distributed systems or clusters of machines. The present disclosure describes embodiments using etcd as an example of the consensus component 245; however, the consensus component 245 is not limited to etcd, and embodiments may be implemented with different types of consensus components that have a quorum requirement in the manner described herein. Examples of other distributed databases that use a consensus component include MongoDB and Cassandra.

The control plane 215 may also include an application programming interface (API) server (not shown) that exposes an API that lets end users, different parts of the cluster, and external components communicate with one another. In an exemplary Kubernetes implementation, the API server exposes the Kubernetes API.

In embodiments, the control plane 215 includes at least one additional node 240z that runs a quorum loss module 250, which may comprise one or more modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. The node 240z may comprise the computer 101 of FIG. 1 and the quorum loss module 250 may be executable by the processing circuitry 120 of FIG. 1 to perform one or more steps of the inventive methods as described herein.

In embodiments, the quorum loss module 250 is configured to intercept a command that originates external to a cluster, wherein the cluster comprises plural nodes each running a consensus component, and wherein a defined number of the consensus components are required for quorum; predict a change to a current state of the cluster based on the command; determine whether the change to the current state of the cluster would result in quorum loss; in response to determining the change to the current state of the cluster would result in quorum loss, prevent execution of the command and sending an alert to a user that issued the command; and in response to determining the change to the current state of the cluster would not result in quorum loss, permit execution of the command.

In another embodiment, the steps described above as being performed by the quorum loss module 250 are alternatively configured to be performed by a daemon 255 running on each of the nodes 240a-n as shown in FIG. 2. Each node 240a-n may run other processes in addition to the consensus component 245 and the daemon 255 may be configured to monitor the processes that are running on a node.

With continued reference to FIG. 2, the environment 205 comprises a network 260 that connects the cluster 210 to an admin device 265. The network 260 may comprise the LAN 102 of FIG. 1 and the admin device 265 may comprise one or more instances of the EUD 103 of FIG. 1. In embodiments, the admin device 265 provides an admin user interface (UI) 270 that provides a user with administrative access to the cluster 210. In one example, the nodes 240a-n comprise virtual machines (VMs) and the admin UI 270 comprises a VM management interface such as a VM management dashboard by which a user can provide input to control operational aspects of the nodes 240a-n. In another example, the admin UI 270 comprises a Unix shell by which a user can provide input (e.g., command line commands) to control operational aspects of the nodes 240a-n and/or operational aspects of the network in which the nodes 240a-n communicate with each other.

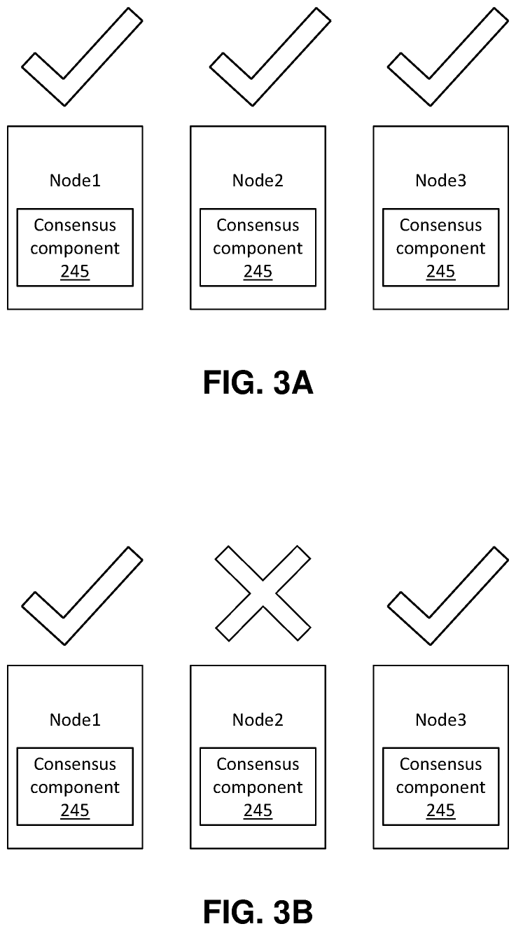

FIGS. 3A and 3B show an exemplary use case that illustrates aspects of the present invention. In FIGS. 3A and 3B, node1, node2, and node3 correspond to nodes 240a-n of FIG. 2 where the number “n” equals three. In this example, the cluster (e.g., cluster 210 of FIG. 2) is a Kubernetes cluster and the consensus component 245 on each node comprises an etcd pod. As described herein, etcd is a backend key-value store that keeps track of the state of a cluster such as cluster 210 of FIG. 2. In embodiments, etcd is a consensus-based system in that a quorum of the etcd pods must be in agreement before making an update to the state of the cluster. Failure to maintain a quorum requires restoring the etcd database from a backup. As such, it is advantageous to maintain a quorum of the etcd pods at all times for the purpose of avoiding the time and expense of restoring from a backup. In embodiments, the minimum number of available etcd pods required for quorum “q” is given by Expression 1.

q=(n/2)+1 (1)

In Expression 1, the value derived inside the parenthesis may be truncated prior to adding the value of one. In the example of FIGS. 3A and 3B, since the total number of etcd pods is n=3, it follows that the minimum number of available etcd pods required for quorum is q=2. Expression 2 is a Boolean expression for computing quorum loss in which “a” is the number of currently available (e.g., healthy) etcd pods and “u” is the number of etcd pods that will become unavailable as the result of a change to the infrastructure of the cluster.

(a−u)<q (2)

In FIG. 3A, each of the consensus components 245 (e.g., etcd pods) is currently available as indicated by the check mark above each of node1, node2, and node3. In embodiments, a consensus component 245 is available when its node is able to communicate with the other ones of the nodes. Conversely, a consensus component 245 is unavailable when its node is not able to communicate with the other ones of the nodes. A node might be unable to communicate with other ones of the nodes when the node is down (e.g., powered off) or when the node is isolated from the other nodes in the network, e.g., by a firewall or software defined network barrier.

In the example of FIG. 3A, one of node1, node2, and node3 can become unavailable and the cluster maintains quorum. For example, FIG. 3A shows a situation where the number of currently available etcd pods is a=3. If one of those pods were to become unavailable, then u=1, such that Expression 2 would indicate “false” for quorum loss (e.g., since (a−u)<q in this situation would be 3−1<2=false).

In FIG. 3B, two of the consensus components 245 (e.g., etcd pods) are currently available as indicated by the check mark above each of node1 and node3, while one of the consensus components 245 is currently unavailable as indicated by the “X” above node2. In this situation, if one of node1 and node3 were to become unavailable, then quorum would be lost. This is because in FIG. 3B, the number of currently available etcd pods is a=2. If one of those pods were to become unavailable, then u=1, such that Expression 2 would indicate “true” for quorum loss (e.g., since (a−u)<q in this situation would be 2−1<2=true).

Implementations of the invention preempt such quorum loss by preventing the execution of external commands (e.g., commands from admin UI 270 of FIG. 2) that would cause the consensus components 245 of the control plane to lose quorum. Implementations involve adjudication of a quorum against a quorum state to identify whether the state would constitute loss of quorum. In embodiments, quorum states are computed or projected from intended infrastructure state changes, whereby quorum loss is detected before the desired infrastructure state change is enacted.

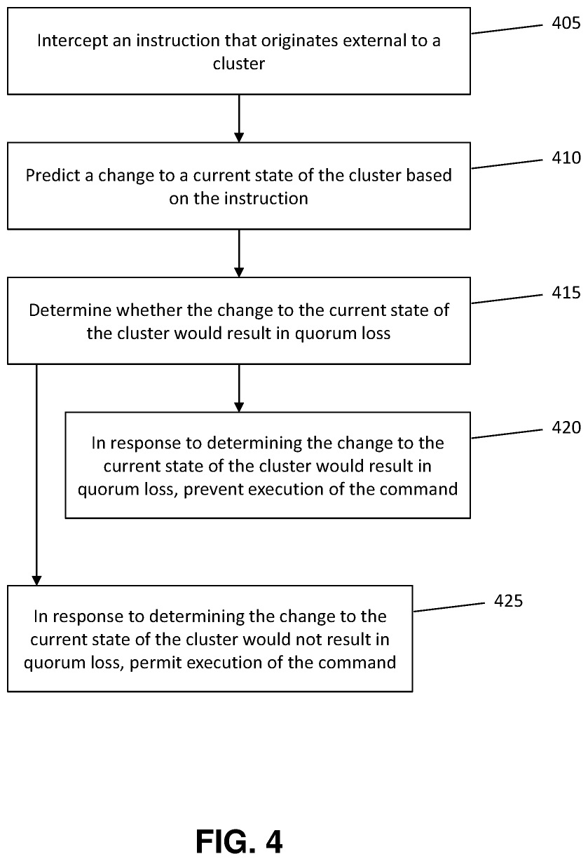

FIG. 4 shows a flowchart of an exemplary method in accordance with aspects of the present invention. Steps of the method may be carried out in the environment of FIG. 2 and are described with reference to elements depicted in FIG. 2.

At step 405, the system intercepts an instruction that originates external to a cluster. In embodiments, the quorum loss module 250 (or the daemon 255) intercepts an instruction that originates at the admin device 265 that is external to the cluster 210. In embodiments, the instruction is intercepted by monitoring system level commands of the admin device 265. In embodiments, the cluster comprises plural nodes 240a-n each running a consensus component 245. The cluster may include other nodes that do not run the consensus component. In embodiments, a defined number “q” of the consensus components 245 are required for quorum. The instruction may include but is not limited to: user input received via a user interface (such as a button, slider, or switch selection in the interface); an API call (such as a rest API call); a command line command (such as from a unix shell); and an input received via a VM dashboard.

At step 410, the system predicts a change to the current state of the cluster based on the instruction intercepted at step 405. In embodiments, the quorum loss module 250 (or the daemon 255) predicts the change to the current state of the cluster by determining a number of the nodes of the cluster that would become unavailable as a result of executing the instruction. The number of nodes that would become unavailable may be determined using rules and/or machine learning.

At step 415, the system determines whether the change to the current state of the cluster (from step 410) would result in quorum loss. In embodiments, the quorum loss module 250 (or the daemon 255) uses the current state of the cluster, the change to the current state of the cluster, and a predefined expression to determine whether the change to the current state of the cluster would result in quorum loss. In embodiments, the current state of the cluster is represented by the number “a” of currently available consensus components, the change to the current state of the cluster is represented by the number “u” of consensus components that would become unavailable, and the predefined expression is Expression 2.

At step 420, in response to determining the change to the current state of the cluster would result in quorum loss, the system prevents execution of the instruction. In embodiments, the quorum loss module 250 (or the daemon 255) interacts with the admin device 265 to prevent execution of the instruction.

At step 425, in response to determining the change to the current state of the cluster would not result in quorum loss, the system permits execution of the instruction. In embodiments, the quorum loss module 250 (or the daemon 255) interacts with the admin device 265 to permit execution of the instruction.

In an embodiment of the method of FIG. 4, the nodes are in a control plane 215 of the cluster 210, and the consensus components 245 comprise instances of a distributed database, such as but not limited to etcd.

In an embodiment of the method of FIG. 4, the change to the current state of the cluster comprises a number of the consensus components that would become unavailable as a result of executing the instruction. A non-limiting example of a consensus component becoming unavailable is if the instruction caused a node to shut down while that node is running one of the consensus components. Another non-limiting example of a consensus component becoming unavailable is a command or instruction that manipulates an SDN (Software Defined Network) or firewall that then blocks communication between one or more consensus components.

In an embodiment of the method of FIG. 4, the instruction bypasses a control plane of the cluster. An external instruction may bypass the control plane of the cluster and affect the underlying infrastructure directly. Such an instruction bypasses the PDBs (Pod Disruption Budgets) that are in the control plane and that help safeguard quorum. For an instruction that bypasses the cluster management layer, protection capabilities within the cluster itself are ineffective. In one example, the instruction originates at a computing device (e.g., admin device 265) that is external to the cluster (e.g., cluster 210). In one example, the instruction comprises a unix shell or VM dashboard command that shuts down one or more of the nodes 245a-n. In another example, the instruction comprises a unix shell or VM dashboard instruction that changes network settings that result in isolating one or more of the nodes 245a-n from other ones of the nodes. Other types of instruction may also be intercepted and handled in the manner described herein.

In an embodiment of the method of FIG. 4, the number of the consensus components that would become unavailable as a result of executing the instruction may be predicted using one or more predefined rules associated with various common instructions. The rules may specify a type of instruction by name and may specify a change to the cluster. An example of one such rule is: if host is ‘cp’ and cmd contains ‘shutdown’, then increment “u” by 1. Other rules may be used.

In an embodiment of the method of FIG. 4, the number of the consensus components that would become unavailable as a result of executing the instruction may be predicted using a machine learning algorithm. For example, the system may obtain historic data including past instructions and the changes to the cluster that resulted from the past commands. The system may analyze this data using machine learning to learn patterns and/or associations between types of instruction and numbers of consensus components that become unavailable as a result of the instructions. Then, when a new instructions is intercepted, the system may use the learned patterns and/or associations to predict a change to the cluster that will result from executing the new instruction.

In an embodiment of the method of FIG. 4, the method further comprises in response to determining the change to the current state of the cluster would result in quorum loss, sending an alert to a user that issued the instruction. In embodiments, the quorum loss module 250 (or the daemon 255) sends a message to the admin device 265 for display via the admin UI 270, where the message may explain that the instruction was blocked and why it was blocked.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
intercepting a instruction that originates external to a cluster, wherein the cluster comprises plural nodes each running a consensus component, and wherein a defined number of the consensus components are required for quorum;
predicting a change to a current state of the cluster based on the instruction;
determining whether the change to the current state of the cluster would result in quorum loss;
in response to determining the change to the current state of the cluster would result in quorum loss, preventing execution of the instruction; and
in response to determining the change to the current state of the cluster would not result in quorum loss, permitting execution of the instruction.

2. The computer-implemented method of claim 1, wherein:
the nodes are in a control plane of the cluster; and
the consensus components comprise instances of a distributed database.

3. The computer-implemented method of claim 1, wherein the change to the current state of the cluster comprises a number of the consensus components that would become unavailable as a result of executing the instruction.

4. The computer-implemented method of claim 1, wherein the instruction bypasses a control plane of the cluster.

5. The computer-implemented method of claim 1, wherein the change to the current state of the cluster is predicted using a predefined rule.

6. The computer-implemented method of claim 1, wherein the change to the current state of the cluster is predicted using a machine learning algorithm.

7. The computer-implemented method of claim 1, further comprising, in response to determining the change to the current state of the cluster would result in quorum loss, sending an alert to a user that issued the instruction.

8. A computer program product comprising one or more computer readable storage media having program instructions collectively stored on the one or more computer readable storage media, the program instructions executable to:
intercept an instruction that originates external to a cluster, wherein the cluster comprises plural nodes each running a consensus component, and wherein a defined number of the consensus components are required for quorum;
predict a change to a current state of the cluster based on the instruction;
determine whether the change to the current state of the cluster would result in quorum loss;
in response to determining the change to the current state of the cluster would result in quorum loss, prevent execution of the instruction; and
in response to determining the change to the current state of the cluster would not result in quorum loss, permit execution of the instruction.

9. The computer program product of claim 8, wherein:
the nodes are in a control plane of the cluster; and
the consensus components comprise instances of a distributed database.

10. The computer program product of claim 8, wherein the change to the current state of the cluster comprises a number of the consensus components that would become unavailable as a result of executing the instruction.

11. The computer program product of claim 8, wherein the instruction bypasses a control plane of the cluster.

12. The computer program product of claim 8, wherein the change to the current state of the cluster is predicted using a predefined rule.

13. The computer program product of claim 8, wherein the change to the current state of the cluster is predicted using a machine learning algorithm.

14. The computer program product of claim 8, wherein the program instructions executable to, in response to determining the change to the current state of the cluster would result in quorum loss, send an alert to a user that issued the instruction.

15. A system comprising:
a processor set, one or more computer readable storage media, and program instructions collectively stored on the one or more computer readable storage media, the program instructions executable to:
intercept an instruction that originates external to a cluster, wherein the cluster comprises plural nodes each running a consensus component, and wherein a defined number of the consensus components are required for quorum;
predict a change to a current state of the cluster based on the instruction;
determine whether the change to the current state of the cluster would result in quorum loss;
in response to determining the change to the current state of the cluster would result in quorum loss, prevent execution of the instruction and send an alert to a user that issued the instruction; and
in response to determining the change to the current state of the cluster would not result in quorum loss, permit execution of the instruction.

16. The system of claim 15, wherein:
the nodes are in a control plane of the cluster; and
the consensus components comprise instances of a distributed database.

17. The system of claim 15, wherein the change to the current state of the cluster comprises a number of the consensus components that would become unavailable as a result of executing the instruction.

18. The system of claim 15, wherein the instruction bypasses a control plane of the cluster.

19. The system of claim 15, wherein the change to the current state of the cluster is predicted using a predefined rule.

20. The system of claim 15, wherein the change to the current state of the cluster is predicted using a machine learning algorithm.
